(19) United States
(12) Patent Application Publication
(10) Pub. No.: US 2010/0180080 A1
(43) Pub. Date: Jul. 15, 2010

(54) EXTERNAL STORAGE DEVICE HAVING A SELF-CONTAINED SECURITY FUNCTION

(76) Inventors: Liang-Chun Lin, Hsinchu City (TW); Cheng-Sheng Chan, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/466,389

(22) Filed: May 15, 2009

(30) Foreign Application Priority Data
Jan. 12, 2009 (TW) 098100904

(51) Int. Cl. G06F 12/00; G06F 12/14

(52) U.S. Cl. 711/115; 711/163; 711/E12.001; 711/E12.008; 711/E12.091

(57) ABSTRACT

An external storage device includes a storage device and a bridge. The storage device stores data transmitted from a computer host. The bridge includes a memory unit and a control unit. The memory unit stores a virtual device datum, and the virtual device datum includes an application program. The control unit generates a virtual storage device in the computer host according to the virtual device datum, and executes a security function of the storage device according to the application program.

### BACKGROUND OF THE INVENTION

1. Field of the Invention

The present invention relates to an external storage device, and more particularly, to an external storage device having a self-contained security function.

2. Description of the Prior Art

For expanding the function of the computer system and adapting the requirement of the users, different external devices of the computer are developed. For example, external hard disk or portable storage device can expand the limited storage capacity of the computer system. The external CD-ROM drive or CD-RW drive can expand the function of the computer system accessing the multimedia resource and provide the capability to backup large data. The storage device needs to use a medium device (or a bridge) to communicate with the computer system and transmit data.

Please refer to FIG. 1. FIG. 1 is a block diagram of an external device connected to a computer host according to the prior art. The external device 15 connected to the host 11 receives and stores the data from the host 11. The external device includes a bridge 151 and a storage device 152. The bridge 151 is connected between the host 11 and the storage device 152, for providing a data transmission interface so that the host 11 and the bridge 151 can transmit data according to a first data transmission interface, and the bridge 151 and the storage device 152 can transmit data according to a second data transmission interface. Thus, the data from the host 11, through the bridge 151, can be converted to the data capable of the data transmission with the storage device 152. In addition, the bridge 151 includes a control unit 153 for controlling the operation of the bridge 151 according to the commands of the host 11 and performing the data transmission. The storage can be a hard disk. The storage device is connected to the computer host through the bridge. The bridge is in charge of the signal conversion between the storage device and the computer host. For the computer host, the bridge and the storage device form an external storage device. The bridge can generate an external virtual device through the firmware design, and this virtual device can be any external storage device, like flash disk, optical disc drive or HDD. Thus, the computer host will have the virtual storage device besides the real storage device, but actually there is one real external storage device.

The external device in use at present, to generate one virtual storage device or a plurality of virtual storage devices, has to store the virtual device data in the storage device. In this way, the storage capacity of the storage device is decreased, and the data are read in the specific method. The virtual device data stored in the storage device occupies the storage space of the storage device so the user obtains less storage capacity. Moreover, the user may damage the file structure of the storage device when changing the physical storage device. In addition, the storage device has a security function, but the user has to input specific commands to the control unit of the bridge through the application program installed in the computer host, so that the control unit can execute the security function of the storage device. However, the user has to install the application program for the storage device first, so it is inconvenient for portable usage.

### SUMMARY OF THE INVENTION

The present invention provides an external storage device. The external storage device comprises a storage device and a bridge. The storage device stores data transmitted from a computer host. The bridge, connected between the storage device and the computer host, comprises a memory unit and a control unit. The memory unit stores a virtual device datum. The virtual device datum comprises an application program. The control unit generates a virtual storage device in the computer host according to the virtual device datum and executes a security function of the storage device according to the application program.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of an external device connected to a computer host according to the prior art.

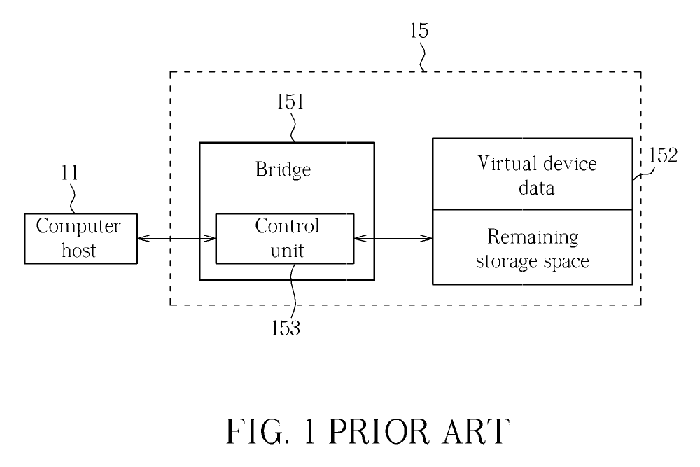

FIG. 2 is a block diagram of the first embodiment of an external device connected to a computer host according to the present invention.

FIG. 3 is a schematic diagram of the application program auto-run according to the present invention.

FIG. 4 is a block diagram of the second embodiment of an external device connected to a computer host according to the present invention.

FIG. 5 is a flow chart of the external device communicating with the computer host according to the present invention.

### DETAILED DESCRIPTION

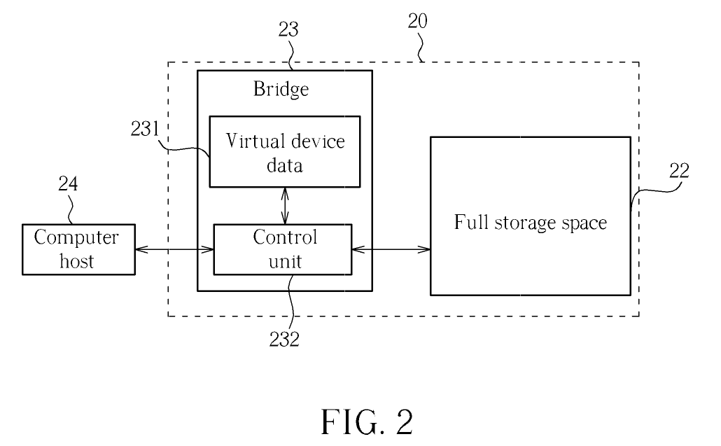

Please refer to FIG. 2. FIG. 2 is a block diagram of the first embodiment of an external device connected to a computer host according to the present invention. The external device 20 comprises a storage device 22 and a bridge 23. The bridge 23 connects to a host 24 according to a first data transmission interface, and determines if the data of the host 24 belongs to the physical storage device 22. If it does, the bridge 23 converts the first data transmission interface to a second data transmission interface, and then stores the data of the computer host 24 in the storage device 22 according to the second data transmission interface. The first data transmission interface comprises Universal Serial Bus (USB) interface, IEEE1394 interface, or External Serial ATA (eSATA) interface. The second data transmission interface comprises Integrated Device Electronics (IDE) interface, Serial ATA (SATA) interface, or Small Computer System Interface (SCSI). The bridge 23 comprises a memory unit 231 and a control unit 232. The memory unit 231 stores a virtual device data. The virtual device data comprises drivers, all kinds of application programs, or all kinds of data. The control unit 232 is connected to the memory unit 231, for controlling the operation of the memory unit 231 and performing the data transmission.

The external device 20 according to the present invention stores the virtual device data in the memory unit 231 of the bridge 23, so the storage device 22 provides the full storage capacity of the physical storage device to the user and prevents the user from damaging the function of the external device when changing the physical storage device. Taking the virtual CD-ROM drive for example, when the external device 20 is connected to the computer host 24, the control unit 232 can read the virtual device data stored in the memory unit 231 and generates a virtual CD-ROM drive in the operating system of the computer host 24. In addition, the operating system of the computer host 24 can use the auto-run function of the CD-ROM to execute the drivers, all kinds of application programs, and all kinds of data stored in the memory unit 231 for the virtual CD-ROM. In this embodiment, the storage device 22 can be a hard disk, CD-ROM drive, or flash memory. The memory unit 231 can be a flash memory, EEPROM or other small-scale memory. The virtual storage device can be a hard disk, CD-ROM drive or portable memory. Therefore, when the external storage device 20 connects to the computer host 24, the computer host 24 can execute the application program installed in the virtual storage device automatically so the user can execute the security function of the storage device through the application program. The security function is provided by the storage device itself so the storage device and the computer host have no incompatible problems which may cause the data damage. Furthermore, the computer host can execute the application program through the virtual storage device generated by the bridge, so the external storage device 20 is portable.

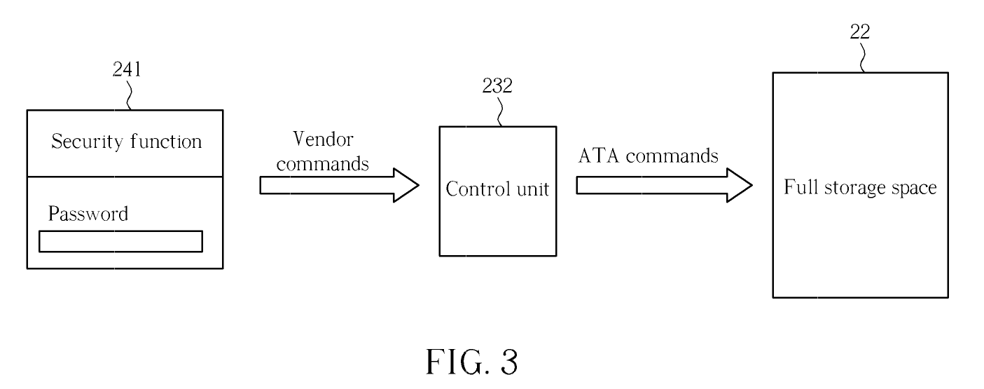

Please refer to FIG. 3. FIG. 3 is a schematic diagram of the application program auto-run according to the present invention. The application program is stored in the memory unit. When the external storage device is connected to the computer host, the control unit generates a virtual storage device in the computer host, so the computer host can execute the application program through the virtual device, without installing application. The application program has a plurality of vendor commands to communicate with the control unit and further provides an operating interface of the security function for the user. The hard disk has the security function according to the ATA/ATAPI standard for the data security. The security function allows the user to set a password. When the security function is enabled and the password is set, the data in the hard disk can not be accessed by any commands until the password is inputted to disable the security function. Thus, by the application program stored in the memory unit, the external storage device of the present invention provides the self-contained security function, so the user can execute the security function of the external storage through the application program when connecting the external storage device to the computer host.

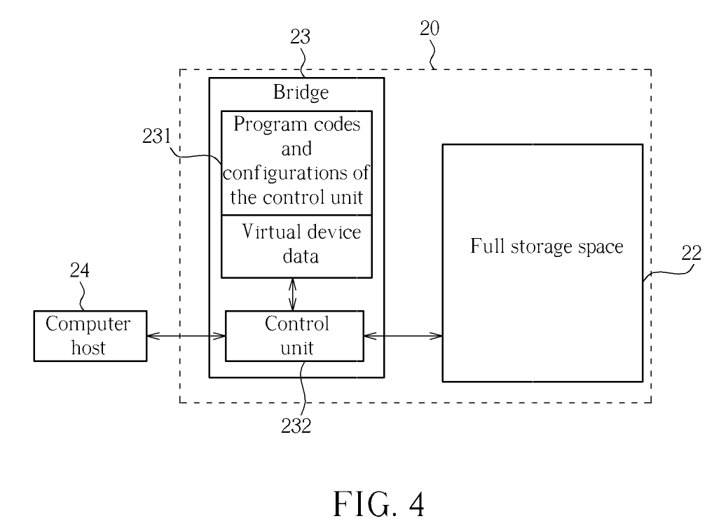

Please refer to FIG. 4. FIG. 4 is a block diagram of the second embodiment of an external device connected to a computer host according to the present invention. In this embodiment, the memory unit 231 can store the program codes and configurations of the control unit 232. In general, the bridge generates the virtual storage device for specific applications, so the memory unit 231 of the bridge can store the program codes with different functions and related configurations of the control unit 232 according to different requirements. When the external storage device is enabled, the application function of the external storage device is determined according to the program codes stored in the memory unit 231. In addition, the virtual storage device and the storage device connecting to the computer host 24 are controlled by the program codes of the control unit 232.

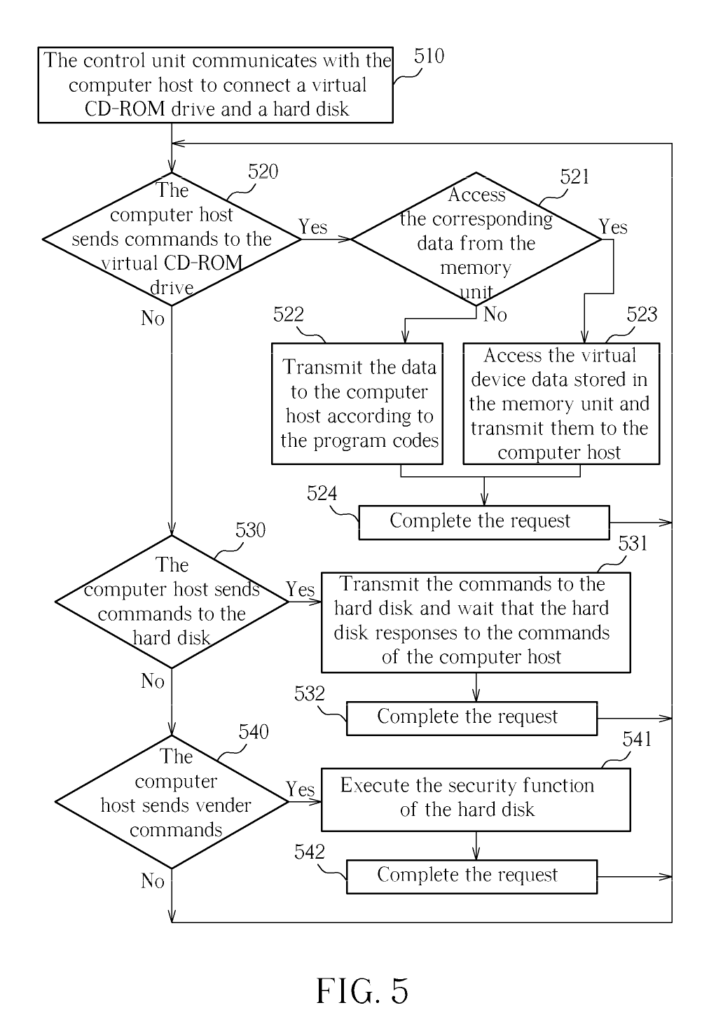

Please refer to FIG. 5. FIG. 5 is a flow chart of the external device communicating with the computer host according to the present invention. The communication between the external device and the computer host comprises the following steps:

Step 510: After reading the program codes and the configurations stored in the memory unit, the control unit communicates with the computer host, and informs the computer host of two storage device existing, for example, a virtual CD-ROM drive and a hard disk.

Step 520: The control unit determines if the computer host sends commands to the virtual CD-ROM drive. If it does, go to the step 521; else, go to the step 530.

Step 521: The control unit determines if accesses the corresponding data from the memory unit according to the program. If the control unit does not access the data from the memory unit, go to the step 522; if the control unit needs to access the data from the memory unit, go to the step 523.

Step 522: The control unit transmits the data to the computer host according to the program codes, and then go to the step 524.

Step 523: The control unit accesses the virtual device data stored in the memory unit and transmits them to the computer host, and then go to the step 524.

Step 524: The control unit completes the request from the computer host and waits the next commands; go to the step 520.

Step 530: The control unit determines if the computer host sends commands to the hard disk. If it does, go to the step 531; else, go to the step 540.

Step 531: The control unit transmits the commands to the hard disk and waits that the hard disk responses to the commands of the computer host; go to the step 532.

Step 532: The control unit completes the request from the computer host and waits the next commands; go to the step 520.

Step 540: The control unit determines if the computer host sends vender commands. If it does, go to the step 541; else, go to the step 520.

Step 541: The control unit executes the security function of the hard disk; go to the step 520.

Step 542: The control unit completes the request from the computer host and waits the next commands; go to the step 520.

In conclusion, the external storage device includes a storage device and a bridge. The storage device stores data transmitted from a computer host. The bridge includes a memory unit and a control unit. The memory unit stores a virtual device datum, and the virtual device datum includes an application program. The control unit generates a virtual storage device in the computer host according to the virtual device datum, and executes a security function of the storage device according to the application program. The computer host can execute the security function of the storage device by the virtual storage device generated by the bridge, so the portable usage of the external storage device is improved.

Those skilled in the art will readily observe that numerous modifications and alterations of the device and method may be made while retaining the teachings of the invention.

What is claimed is:

1. An external storage device, comprising:
a storage device, for storing data transmitted from a computer host; and
a bridge, connected between the storage device and the computer host, comprising:
a memory unit, for storing a virtual device datum, the virtual device datum comprising an application program; and
a control unit, for generating a virtual storage device in the computer host according to the virtual device datum and executing a security function of the storage device according to the application program.

2. The external storage device of claim 1, wherein the storage device is a hard disk, a CD-ROM drive, or a flash memory.

3. The external storage device of claim 1, wherein the control unit accesses the virtual storage device or the storage device according to commands of the computer host.

4. The external storage device of claim 1, wherein the application program transmits vender commands to the control unit so as to execute the security function of the storage device.

5. The external storage device of claim 1, wherein the virtual storage device is a hard disk, a CD-ROM drive, or a portable memory.

6. The external storage device of claim 1, wherein the virtual device datum comprises a driver.

7. The external storage device of claim 1, wherein the memory unit further stores program codes and configurations of the control unit.

8. The external storage device of claim 1, wherein the bridge connects to the computer host according to a first data transmission interface, so as to convert the data of the computer host from the first data transmission interface to a second data transmission interface.

9. The external storage device of claim 8, wherein the bridge connects to the storage device according to the second data transmission interface.

10. The external storage device of claim 1, wherein the first data transmission interface is USB interface, IEEE1394 interface, or eSATA (External Serial ATA) interface.

11. The external storage device of claim 8, wherein the second data transmission interface is IDE interface, SATA interface, or SCSI interface.
